(19) United States
(12) Patent Application Publication
(10) Pub. No.: US 2004/0136462 A1
(43) Pub. Date: Jul. 15, 2004

(54) Method and apparatus for ensuring receiver lock

(76) Inventors: Albert Chen, Fremont, CA (US); Gary M. Rigsby, San Diego, CA (US); Prabhansu Chakrabarti, Sunnyvale, CA (US)

Correspondence Address: B. Noel Kivlin, Meyertons, Hood, Kivlin, Kowert & Goetzel, P.C., P.O. Box 398, Austin, TX, 78767, US

(21) Appl. No.: 10/341,238

(22) Filed: Jan. 13, 2003

(51) Int. Cl. H04B 3/00

(52) U.S. Cl. 375/257

(57) ABSTRACT

A system and method for training a receiver circuit. In one embodiment, a first integrated circuit (IC) may be coupled to a plurality of signal lines. One or more of the signal lines may be coupled to a second IC as well. The first IC may include a plurality of transmitters, while the second IC may include one or more receivers. On a first signal line, a transmitter of the first IC may transmit a first bit pattern to a receiver in the second IC. On a first plurality of signal lines (not including the first signal line), transmitters in the first IC may transmit a second bit pattern. The receiver in the second IC, responsive to receiving the bit pattern, may be configured (i.e. trained) to lock onto bits transmitted to it over the signal line.

### BACKGROUND OF THE INVENTION

1. Field of the Invention

This invention relates to signal transmission in electrical/electronic systems, and more particularly, to ensuring the ability of a receiver to lock onto data in high-speed interconnections.

2. Description of the Related Art

In designing high-speed digital systems, several different issues must be dealt with in order to ensure signals are transmitted and received at their proper values. Parasitic circuit parameters (e.g. parasitic capacitances and/or inductances) and their resulting effects on transmitted signals must be considered for the successful design of high-speed digital systems. Parasitic circuit parameters may lead to various types of noise which may degrade transmitted signals and possibly prevent the correct values from being read by a receiver circuit.

Types of noise that must be dealt with include cross-talk, inter-symbol interference, and timing noise (skew and data jitter). Cross talk may be defined as noise caused by one signal which may be coupled to a different signal, and may be caused by parasitic capacitance or mutual inductance between signal lines. Inter-symbol interference may be defined as a first signal, transmitted over a signal line at a first time, interfering with a second signal transmitted over the same signal line at a subsequent time. This type of noise may be a result of a mismatched line termination impedance. Because of the impedance mismatch between the signal line and its termination, the first signal may cause energy reflections in the signal line which may corrupt the second subsequently transmitted signal. The corruption may in some cases cause an incorrect signal data value to be read by the receiver.

Timing noise, as noted above, may include data skew and data jitter. Data skew may be generally defined as the average delay between on signal relative to another (e.g. clock) signal. Data jitter may be defined as a cycle-to-cycle variation of when a signal transition occurs. Jitter may result from other noise sources (such as those discussed above) causing the point when a transition is detected to move.

In order for high-speed digital systems to properly function, receivers must be configured to read the correct signal data values at the correct time. Thus, the design of these digital systems must take into account the various effects of system noise on the transmission of signals. In many such digital system, testing is conducted upon system start up in order to ensure the receivers may lock on to transmitted data signals at the correct times in order to read the correct values. Such tests typically involve the transmission of a number of data bits from system transmitters to corresponding receivers. The transmissions may be conducted to simulate a worst-case noise scenario for each signal path. However, such tests may require a high number of signal transmissions, and may thus be both time and power consuming.

Another method of overcoming these problems is known as bit balancing. Bit balancing is a technique wherein the number of logic 1's and logic 0's on a data bus may be balanced by encoding the bits prior to transmission. This may ensure that the amount of energy on the data bus is relatively constant from one transmission to the next. However, bit balancing may require extra encoding and decoding circuitry. This extra circuitry may require additional power consumption and may limit the speed at which transmissions may be conducted on the data bus.

### SUMMARY OF THE INVENTION

A system and method for training a receiver circuit is disclosed. In one embodiment, a first integrated circuit (IC) may be coupled to a plurality of signal lines. One or more of the signal lines may be coupled to a second IC as well. The first IC may include a plurality of transmitters, while the second IC may include one or more receivers. On a first signal line, a transmitter of the first IC may transmit a first bit pattern to a receiver in the second IC. On a first plurality of signal lines (not including the first signal line), transmitters in the first IC may transmit a second bit pattern. The receiver in the second IC, responsive to receiving the bit pattern, may be configured (i.e. trained or calibrated) to lock onto bits transmitted to it over the signal line.

### BRIEF DESCRIPTION OF THE DRAWINGS

Other aspects of the invention will become apparent upon reading the following detailed description and upon reference to the accompanying drawings in which:

FIG. 1 is a drawing of one embodiment of a transmitter coupled to a receiver by a signal line;

FIG. 2 is a drawing of one embodiment of an eye diagram;

FIG. 3 is a flow diagram of one embodiment of a method for training a receiver circuit;

FIG. 4 is an illustration showing an embodiment of an aggressor bit pattern and an embodiment of a victim bit pattern;

FIG. 5A is a block diagram illustrating one embodiment of a pair of integrated circuits coupled by signal lines and configured to perform an embodiment of the method of FIG. 3;

FIG. 5B is a block diagram illustrating another embodiment of a pair of integrated circuits coupled by signal lines and configured to perform an embodiment of the method of FIG. 3; and

FIG. 5C is a block diagram illustrating another embodiment of a pair of integrated circuits coupled by signal lines and configured to perform an embodiment of the method of FIG. 3.

While the invention is susceptible to various modifications and alternative forms, specific embodiments thereof are shown by way of example in the drawings and will herein be described in detail. It should be understood, however, that the drawings and description thereto are not intended to limit the invention to the particular form disclosed, but, on the contrary, the invention is to cover all modifications, equivalents, and alternatives falling with the spirit and scope of the present invention as defined by the appended claims.

### DETAILED DESCRIPTION OF THE INVENTION

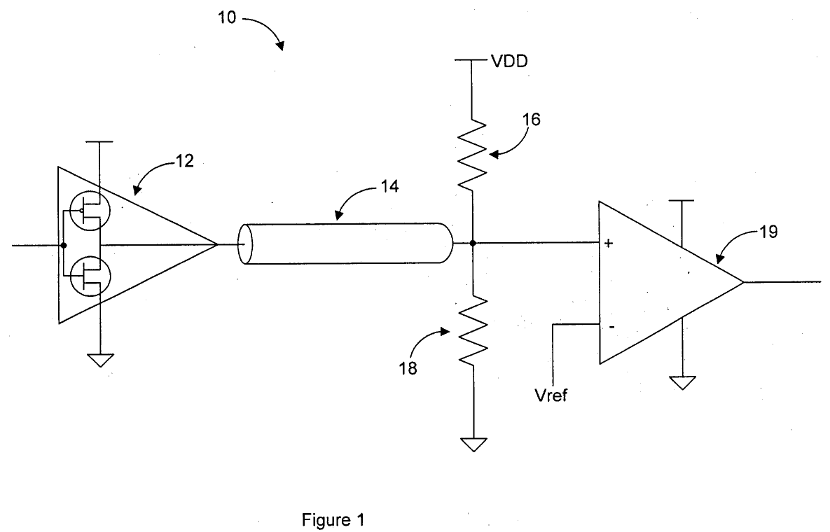

Turning now to FIG. 1, a drawing of one embodiment of a transmitter coupled to a receiver by a signal line is shown. In the embodiment shown, circuit 10 includes transmitter 12 and receiver 19, which are coupled by signal line 14. Signal line 14 may be a single-mode transmission line in this embodiment, although other embodiments (e.g. differential mode) are possible and contemplated. Signal line 14 may be center terminated by resistor 16, coupled to a voltage plane, and resistor 18, which may be coupled to a reference plane. These two resistors may be of equal resistance value. The resistance value of these resistors may be chosen to effectively terminate the transmission line, thereby preventing or minimizing reflections and other transmission line effects. However, despite effective termination of the transmission line, it may still be necessary to account for factors that may potentially cause signal degradation.

Transmitter 12 may transmit signals to receiver 19 via signal line 14. Although not explicitly shown here, transmitter 12 and receiver 19 may be clocked circuits, and thus signal transmissions may include bit patterns.

Both transmitter 12 and receiver 19 may be located in an integrated circuit (IC). In one embodiment, both transmitter 12 and receiver 19 may be located in the same integrated circuit. In another embodiment, transmitter 12 and receiver 19 may each be located in different IC's. Both transmitter 12 and receiver 19 may be part of a transceiver circuit, which may include both a transmitter and a receiver. Transceiver circuits may be used on bi-directional signal lines. Receiver 19 may also be programmable to detect transmitted bits at certain voltage or current levels, and further programmed to sample the received signals at a given time within a transmission/reception cycle. In embodiments where the receiver circuits are clocked, the sampling may occur at a certain time within the clock cycle (or at multiple times in the clock cycle in systems employing double data rate technology). The timing and voltage/current levels at which signals are sampled and their values detected may be determined by a training sequence, which will be discussed in further detail below. The training sequence may program receiver 19 for the specific timing and voltage/current levels at which signals are sampled.

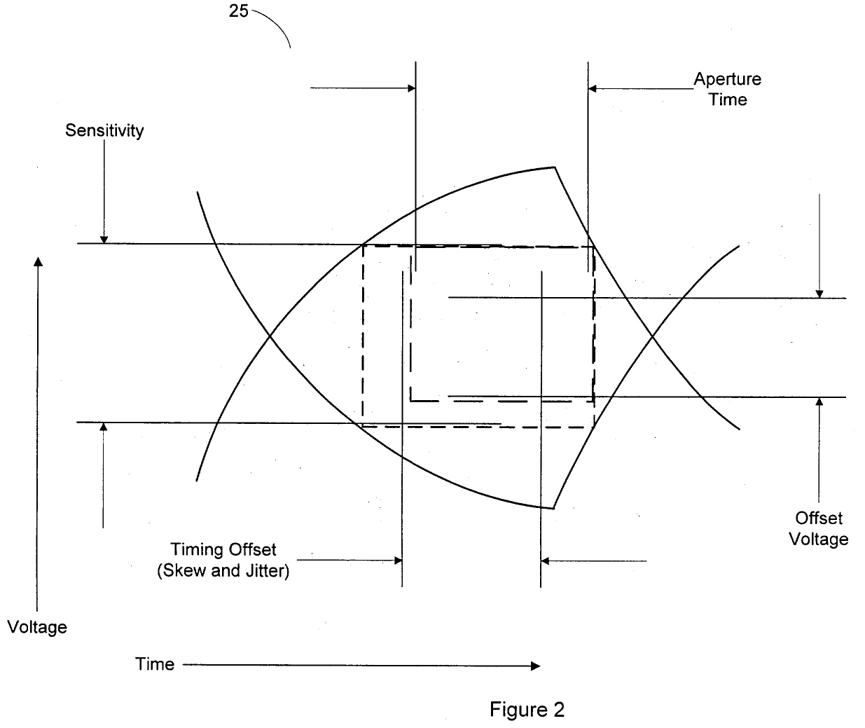

FIG. 2 is a drawing of one embodiment of an eye diagram. The eye diagram may be used to represent the parameters by which a receiver may detect an electrical quantity and recover a symbol (i.e. bit) from it. In general, the receiver must typically detect the electrical quantity within the enclosed area of the eye diagram in order to recover the transmitted bit at its correct logic value.

The enclosed area, known as the eye opening, is determined by two dimensions. One of these dimensions is known as sensitivity, which may be defined as the amount of voltage necessary to generate a full-swing output (this quantity may be current in some cases). In terms of time, the critical dimension is the aperture time. Both voltage offsets and timing offsets (skew and jitter) may be defined as well. It may be preferable for the receiver to have low offsets in both the voltage and time dimensions.

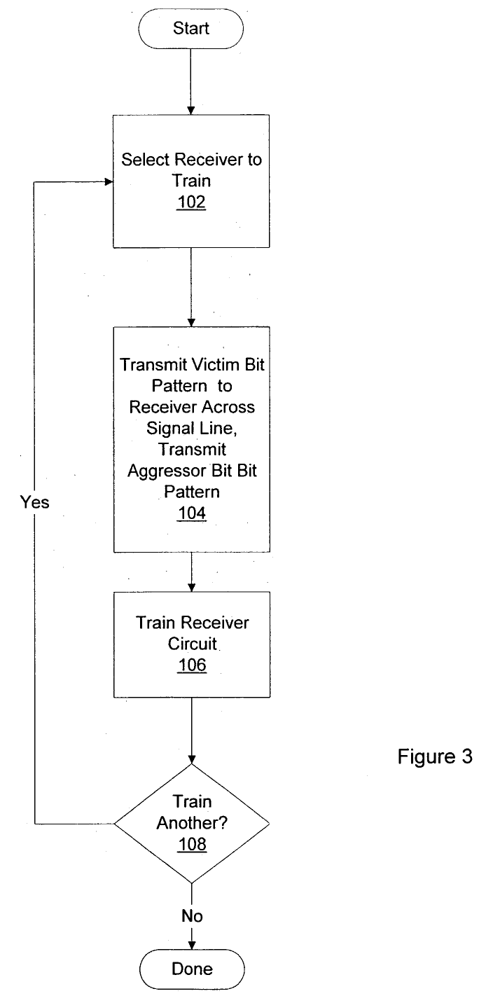

In the example shown, two rectangles are shown, defined by dashed lines. The larger of these two rectangles defines a gross voltage margin on the vertical axis and a gross timing margin on the horizontal axis. The smaller of the two rectangles may be defined on at least one side by a timing offset on the horizontal axis and a voltage offset on the vertical axis. For many receivers, it is critical that the smaller of the two rectangles be within the larger of the two rectangles in order to ensure that the receiver may recover data from received signals under even the worst-case scenarios. The method described below in reference to FIG. 3 is designed to ensure that receivers in a system are trained, (i.e. calibrated) such that the voltage and timing offsets result in the smaller of the two rectangles being entirely within the larger of the two rectangles. This may be performed by transmitting bit patterns that ensure a worst-case noise scenario on a signal line coupled to the receiver being trained. The training of receivers may ensure that they lock on to the received bits (i.e. recover the correct data values from received signals).

FIG. 3 is a flow diagram of one embodiment of a method for training a receiver circuit. Method 100 begins with the selection of a receiver (102) to train, i.e. program to detect signal values (e.g. logic high or logic low) at certain voltage or current levels as well as training the receiver to sample the signal at a certain time. The method may be performed at various times during the operation of a system having receivers that may need training. In one embodiment, the method may be performed during system startup.

Following the selection of a receiver, a transmitter coupled to the receiver may transmit a pattern of “victim” bits. Concurrent with the transmitting of the victim bits, other transmitters may transmit a pattern of “aggressor” bits on signal lines that are adjacent to the signal line of the receiver being trained (104). The aggressor bit pattern may be designed to induce noise into the signal line upon which the victim bit pattern is transmitted. In particular, the aggressor bit pattern may be designed in order to induce a worst-case noise scenario on the signal line on which the victim bit pattern is being transmitted. Such noise may include cross talk, inter-symbol interference (ISI), simultaneous switching noise, and so forth. The noise on the signal line upon which the victim bit pattern is conveyed may cause data jitter on the signal line. Data jitter may affect both the voltage and the skew (i.e. delay relative to a clock signal) of the received signals included in the victim bit pattern.

The receiver circuit may be trained in order to properly detect each transmitted signal (106) responsive to receiving the bits of the victim bit pattern. The selected receiver may respond to the data jitter by adjusting the voltage (or current) levels at which signal values are detected and the time within each cycle that received signals are transmitted. In particular, the receiver may be trained, or configured, to detect signal according to certain voltage (or current) levels and sampled at a certain time within each cycle (e.g. relative to a clock signal) such the signals are sampled within the parameters that make up a valid portion of an eye diagram.

Following the training of a receiver, the method may include a decision to train another receiver (108). If another receiver is chosen, the method may return to the receiver selection block (102), and the process may repeat. The method may continue for any number of receivers that may need to be trained to detect valid data bits from received signals. For example, a given IC may be coupled to a bus having a plurality of signal lines. A receiver may be coupled to each of the signal lines. The method may be performed for each of the receivers on the bus. Once the method has been performed for each receiver on the bus, the method may be complete. Alternatively, the method may be performed for other receivers in the system. In some embodiments, the method may be concurrently performed for multiple different buses or multiple signal links.

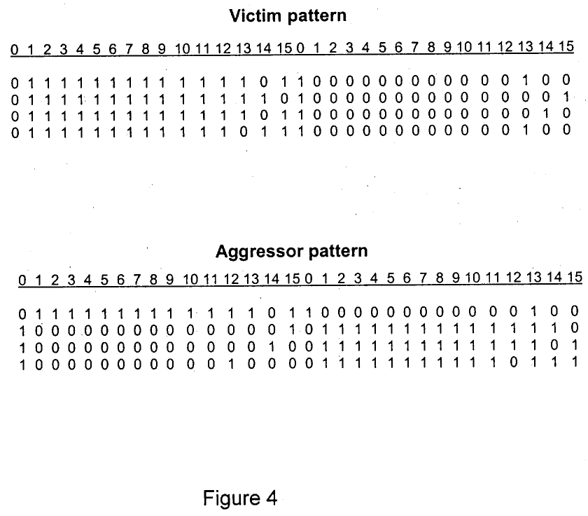

Turning now FIG. 4, an illustration showing embodiments of an aggressor bit pattern and an embodiment of a victim bit pattern is shown. For the embodiments shown, the victim bit pattern may be transmitted on a signal line coupled to a receiver that is being trained, while the aggressor bit pattern may be transmitted on one or more other signal lines. At least one of the signal lines upon which the aggressor bit pattern is transmitted may be physically adjacent to the signal line associated with the receiver being trained.

In the embodiments shown, both the victim bit and aggressor bit patterns include 128 bits. One bit may be transmitted for each cycle, and thus each of the bit patterns may be 128 bit-times in length. At fast clock speeds, training receivers using bit patterns that are 128 bit-times or less in length may allow for a very rapid training process. In some embodiments, this training process may be performed during a system start-up routine. The ability to rapidly train each receiver may limit the impact that such training procedures have on system startup time.

The victim bit and aggressor bit patterns may be transmitted in a substantially victim bits and aggressor bits in some instances. In one embodiment both patterns may be transmitted starting with the first bit in the upper left-hand corner and progressing through each row from left to right. Other embodiments that use different sequences are possible and contemplated.

The aggressor bit pattern may be designed to introduce various forms of noise into the signal line upon which the victim bit pattern is transmitted. For example, at certain points within the aggressor bit pattern, the logic values (and thus their corresponding voltages) may switch from a logic 0 to a logic 1, or vice versa. This may cause a large amount of simultaneous switching noise (SSN). A large amount of SSN may lead to fluctuations in voltage between the power and ground planes, thereby inducing other types of noise into the signal line upon which the victim bit pattern is conveyed. The aggressor pattern may also induce noise into the signal line of the victim bit pattern through cross talk. Residual energy induced into the signal line of the victim bit pattern may further result in inter-symbol interference. Furthermore, as previously noted, the exact transmission times of aggressor bits on various signal lines may be skewed slightly with respect to the time of transmission for the victim bits.

By inducing various forms of noise into the signal line upon which the victim bit is transmitted, the combination of the bit patterns may produce a worst-case noise scenario on the signal line upon which the victim bit pattern is transmitted. Training the receiver to recover the correct value of each received signal under worst case scenarios may ensure that the receiver will function in any noise scenario it may encounter during system operation, thereby increasing system reliability.

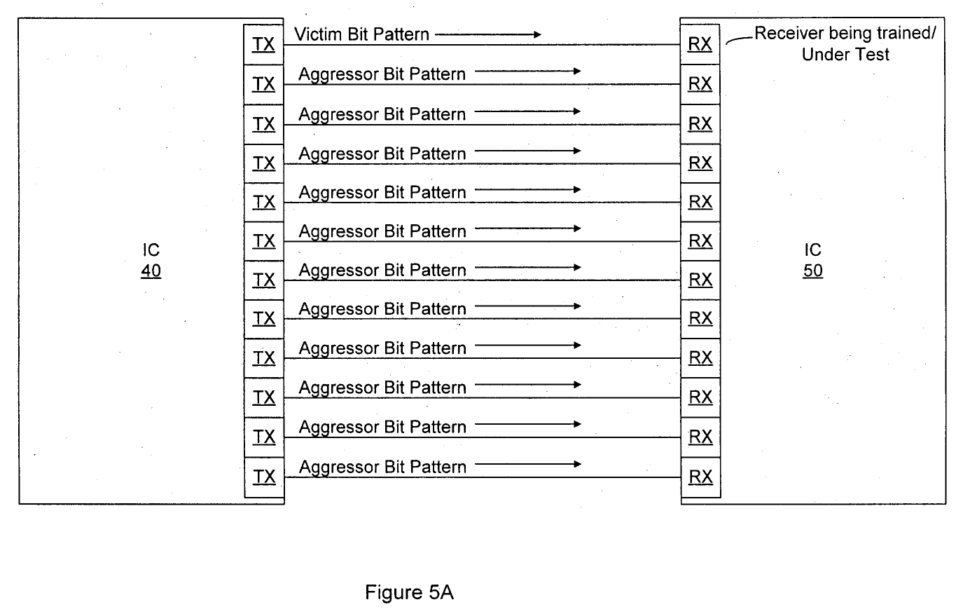

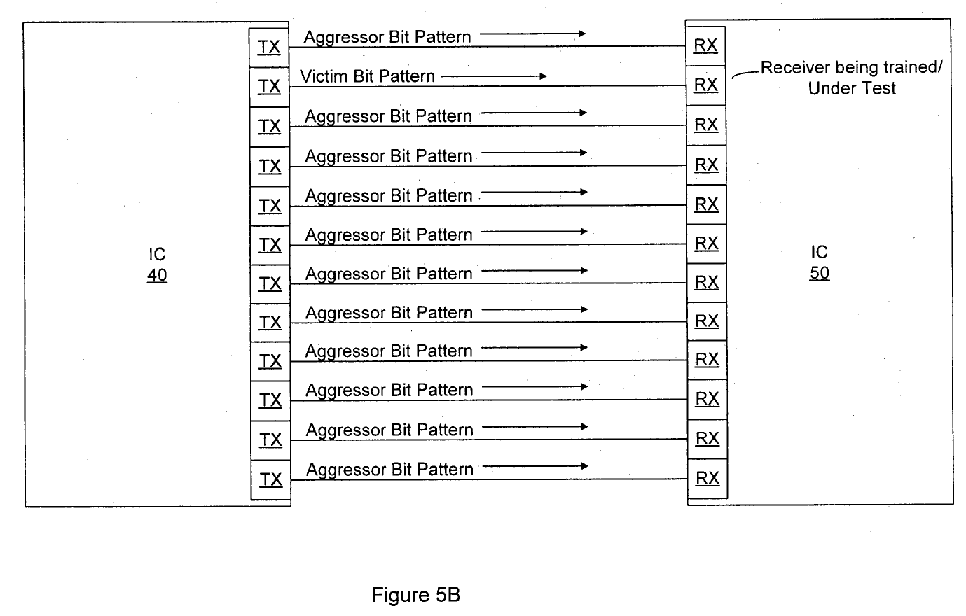

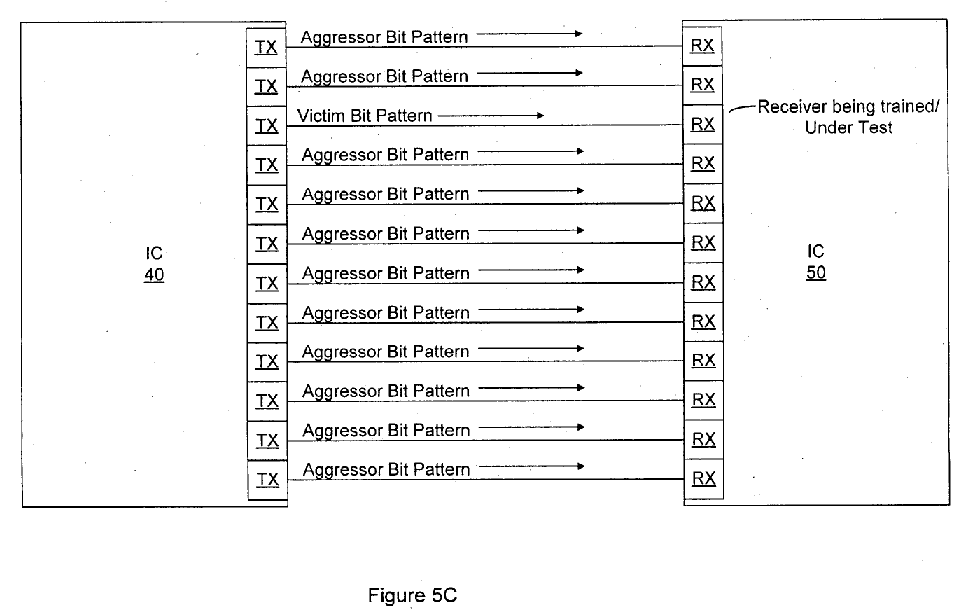

FIGS. 5A, 5B, and 5C are block diagrams illustrating one embodiment of a pair of integrated circuits coupled by signal lines, wherein the receivers may be trained using a training method such as that described above in reference to FIG. 3. In the embodiment shown, IC 40 and IC 50 are coupled by a plurality of signal lines. The signal lines may constitute a bus, or may be signal lines used for other purposes during normal operations. IC 40 may include a plurality of transmitters, while IC 50 may include a plurality of receivers. In embodiments wherein the signal lines are bi-directions, the transmitters and receivers may be part of a transceiver circuit. IC 40 and IC 50 may also include other transmitters or receivers (not shown).

In FIG. 5A, a receiver of IC 50 is being trained, in this case the uppermost receiver shown in the drawing. A victim bit pattern may be transmitted on the signal line associated with the receiver being trained, while an aggressor bit pattern may be transmitted on the other signal lines. It should be noted that it may not be necessary to transmit an aggressor bit pattern on each signal of a bus in some situations. The transmission of the aggressor bit patterns on the other signal lines may result in interactions with the signal line upon which the victim bit pattern is conveyed, thereby inducing a worst-case noise scenario. The receiver may be trained base on the worst case noise scenario in order to ensure that it properly locks on to received data bits regardless of the amount of noise it may encounter during normal operations. The receiver may be trained by comparing the data values of bits recovered from received signals to data values expected for the victim bit pattern. If the correct data value is not received for some bits, the training of the receiver may be repeated. In other cases, training the receiver my be performed to comply with an acceptable error rate.

In FIGS. 5B and 5C, second and third receivers are being trained, and thus the victim bit pattern may be transmitted on their associated signal lines, while the aggressor bit pattern may be transmitted on the other signal lines. In general, this training method may be repeated for each receiver of IC 50. In one embodiment, the victim bit pattern may be “walked down” the bus, starting with a first signal line and progressing through each signal line until each of the associated receivers has been trained. In other embodiment, the receivers may be trained in any order chosen.

While the present invention has been described with reference to particular embodiments, it will be understood that the embodiments are illustrative and that the invention scope is not so limited. Any variations, modifications, additions, and improvements to the embodiments described are possible. These variations, modifications, additions, and improvements may fall within the scope of the inventions as detailed within the following claims.

What is claimed is:

1. A method for training a receiver circuit, the method comprising:
transmitting a first bit pattern onto a first signal line, wherein the first signal line is coupled to a first receiver circuit;
transmitting a second bit pattern on each of a first plurality of signal lines, wherein at least one of the plurality of signal lines is physically adjacent to the first signal line;
configuring the first receiver circuit to lock onto a bit transmitted on the first signal line based upon data received from the first bit pattern.

2. The method as recited in claim 1, wherein the first bit pattern is a victim pattern and the second bit pattern is an aggressor pattern, wherein the aggressor pattern is configured to induce a worst-case data jitter into the victim pattern.

3. The method as recited in claim 2, wherein the first bit pattern and the second bit pattern are each a maximum of 128 bit-times in length.

4. The method as recited in claim 1 further comprising transmitting the first bit pattern on a second signal line and the second bit pattern on each of a second plurality of signal lines, wherein the first plurality of signal lines includes the second signal line and the second plurality of signal lines includes the first signal line, and wherein at least one of the second plurality of signal lines is physically adjacent to the second signal line.

5. The method as recited in claim 4 further comprising a second receiver circuit coupled to the second signal line being configured to lock onto a bit transmitted on the second signal line based upon data received from the first bit pattern.

6. The method as recited in claim 1, wherein configuring the first receiver includes configuring the receiver to detect the value of a signal based on voltage levels.

7. The method as recited in claim 1, wherein configuring the first receiver includes configuring the receiver to sample a signal at given time within a cycle.

8. The method as recited in claim 1, wherein the transmitter is located in a first integrated circuit and the receiver is located in a second integrated circuit.

9. The method as recited in claim 8, wherein each of the first plurality of signal lines is part of a bus, and wherein the bus is coupled to both the first integrated circuit and the second integrated circuit.

10. The method as recited in claim 1, wherein each of the first plurality of signal lines is a single-mode transmission line.

11. A system comprising:
a first integrated circuit including a first plurality of transmitters, the first integrated circuit coupled to a plurality of signal lines; and
a second integrated circuit, the second integrated circuit including a first receiver coupled to receive signal transmissions via a first signal line, the first signal line coupled to at least one of the plurality of transmitters of the first integrated circuit, and wherein the first signal line is physically adjacent to at least one of the plurality of signal lines;
wherein a first transmitter of the plurality of transmitters is configured to transmit a first bit pattern to the receiver and wherein remaining transmitters of the plurality of transmitters are configured to transmit a second bit pattern onto the plurality of signal lines; and
wherein, responsive to data received from the first bit pattern, the first receiver is configured to lock onto a bit transmitted on the first signal line.

12. The system as recited in claim 11, wherein the first bit pattern is a victim pattern and the second bit pattern is an aggressor pattern, wherein the aggressor pattern is configured to induce a worst-case data jitter into the victim pattern.

13. The system as recited in claim 12, wherein the first bit pattern and the second bit pattern are each a maximum of 128 bit-times in length.

14. The system as recited in claim 11, wherein the first integrated circuit is configured to transmit the first bit pattern on a second signal line and the second bit pattern on each of a second plurality of signal lines, wherein the first plurality of signal lines includes the second signal line and the second plurality of signal lines includes the first signal line, and wherein at least one of the second plurality of signal lines is physically adjacent to the second signal line.

15. The system as recited in claim 14, wherein the second integrated circuit includes a second receiver circuit coupled to the second signal line, and wherein the second receiver circuit configured to lock onto a bit transmitted on the second signal line based upon data received from the first bit pattern.

16. The system as recited in claim 1, wherein, responsive to data received from the first bit pattern, the first receiver is configured to detect the value of a signal based on voltage levels.

17. The system as recited in claim 1, wherein responsive to the data received from the first bit pattern, the first receiver is configured to sample a signal at a give time within a cycle.

18. The system as recited in claim 1, wherein each of the first plurality of signal lines is part of a bus, and wherein the bus is coupled to both the first integrated circuit and the second integrated circuit.

19. The system as recited in claim 1, wherein each of the first plurality of signal lines is a single-mode transmission line.
